(19) United States
(12) Patent Application Publication
(10) Pub. No.: US 2008/0289838 A1
(43) Pub. Date: Nov. 27, 2008

(54) INSTRUMENTED JOINT SYSTEM

(76) Inventors: Francois Niarfeix, Tours (FR); Benoit Locher, Saint-Avertin (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 12/101,699

(22) Filed: Apr. 11, 2008

(30) Foreign Application Priority Data
Apr. 19, 2007 (FR) 0754582

(51) Int. Cl. A01B 35/20

(52) U.S. Cl. 172/748

(57) ABSTRACT

The instrumented joint system includes a pivot pin capable of connecting a first part and a moving second part that can pivot with respect to the first part, and a detection assembly for detecting rotation parameters of the second part and which is mounted inside a housing of the pivot pin, the said detection assembly including at least one rolling bearing equipped with an inner ring and with an outer ring, and a sleeve angularly connected to the outer ring. The detection assembly is further provided with a support angularly connected to the pivot pin and on which the inner ring of the bearing is mounted, and with a retaining means for retaining the support axially inside the housing.

### BACKGROUND OF THE INVENTION

1. Field of the Invention

The present invention relates to the field of instrumented joint systems used in particular on earthmoving machine.

More specifically, the present invention relates to an instrumented joint system intended to connect a first part and a moving second part that can pivot with respect to the first part and which is capable of measuring the relative angular displacement of these two parts.

2. Description of the Relevant Art

Instrumented joint systems are conventionally used on the articulated arms of an earthmoving machine in order to control the angular displacement of various articulated elements.

In general, these joint systems include a detection unit which is attached to one axial end of a pivot shaft connecting two parts, one of which is able to pivot with respect to the other.

Now, the earthmoving machine is generally subject to extensive contamination by being sprayed with various contaminants, particularly earth, mud or dust. Furthermore, this machine is cleaned using high-pressure water jets which are liable to damage the detection unit.

Furthermore, because of the way in which it is arranged on the pivot shaft, the unit can also be subjected to knocks as the plant on which it is mounted moves along.

As a result, it will be readily understood that there is a significant risk of the detection unit becoming damaged, thus appreciably reducing its life and the reliability of the earthmoving machine.

To remedy these disadvantages, document EP A 1 092 809 describes an instrumented joint system provided with a main shaft including a recess inside which a unit containing means of detecting rotation parameters is push-fitted. The joint system also includes a secondary shaft and a rolling bearing mounted between the said shaft and the unit for detecting the rotation parameters.

A major disadvantage with this joint system in particular is that it does not allow the unit to be removed easily so that, for example, one of the means designed for detection can be repaired. The problem is that in order to move the unit once it has been fitted a relatively high axial tensile force has to be exerted on the secondary shaft, and this subjects the rolling bearing to excessive stress and may cause damage to this bearing.

### SUMMARY OF THE INVENTION

More specifically, embodiments described herein are aimed at providing an instrumented joint system which is particularly compact, well protected, easy to fit and to remove, and economical.

Furthermore, the embodiments described herein provide a system that is highly dependable.

In one embodiment, an instrumented joint system includes a pivot pin capable of connecting a first part and a moving second part that can pivot with respect to the first part, and a detection assembly for detecting rotation parameters of the second part and which is mounted inside a housing of the pivot pin. The said detection assembly includes at least one rolling bearing equipped with an inner ring and with an outer ring, and a sleeve angularly connected to the outer ring. The detection assembly is further provided with a support angularly connected to the pivot pin and on which the inner ring of the bearing is mounted, and with a retaining means for retaining the support axially inside the housing.

With a system such as this it then becomes possible for the sleeve and support to be removed particularly easily, thereby limiting the risk of damage to the bearing or bearings.

Specifically, providing a means of axial retention makes it possible to avoid mounting the support tightly inside the housing. As a result, once the axial-retention means has been removed, the support and the sleeve can be easily extracted from the housing. This then limits the risk of damage to the rolling bearing or bearings when the system is disassembled.

In other words, with the axial-retention means bearing against the support on which the inner ring of the rolling bearing is mounted and the outer ring of the said bearing mounted in the sleeve which is itself mounted contactlessly in the housing of the pivot pin, it is possible to avoid stressing the bearing excessively when disassembling the system. This is rendered possible, in particular, by the fact that the bearing is mounted without direct contact with the pivot pin.

In one embodiment, the axial-retention means includes a sleeve tube provided with a fixing portion for fixing to the pivot pin and with a bearing surface for the support.

Advantageously, the support includes an outer tubular axial portion positioned inside a cylindrical bore of the housing.

In one embodiment, the outer tubular axial portion at least partially radially surrounds the sleeve leaving a radial gap between the said sleeve and the support.

In one embodiment the support includes a frustoconical wedging portion able to cooperate with a portion of complementary shape belonging to a bore of the housing of the pivot pin.

In an embodiment, the sleeve is completely housed inside the housing of the pivot pin. The sleeve may include a stepped bore in which to mount elements of the detection assembly.

In one embodiment, the detection assembly includes a connector extending axially inside the sleeve. The connector is completely housed inside the sleeve.

In an embodiment, the detection assembly includes an encoder element mounted at one axial end of the support and a sensor element situated axially facing the said encoder element.

In one embodiment, the sensor element is mounted against a printed circuit board bearing against a thrust surface of the sleeve.

Another embodiment described herein relates to an earthmoving machine including a first part, a moving second part that forms an arm able to pivot with respect to the first part, at least one pivot pin capable of connecting the parts together, and a detection assembly for detecting rotation parameters of the second part and which is mounted inside a housing of the pivot pin. The said detection assembly includes at least one rolling bearing equipped with an inner ring and with an outer ring, and a sleeve angularly connected to the outer ring. The detection assembly is further provided with a support angularly connected to the pivot pin and on which the inner ring of the bearing is mounted, and with a retaining means for retaining the support axially inside the housing.

In other words, the detection assembly includes a support for mounting the inner ring of the bearing and a means of locking the support in position inside the housing.

### BRIEF DESCRIPTION OF THE DRAWINGS

The present invention will be better understood from reading the detailed description of an embodiment which is taken by way of entirely nonlimiting example and illustrated by the attached drawing in which:

FIG. 1 is a view in axial section of an instrumented joint system according to the invention;

FIG. 2 is a detailed view of FIG. 1; and

FIG. 3 is a perspective view of a module of the joint system of FIG. 1.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

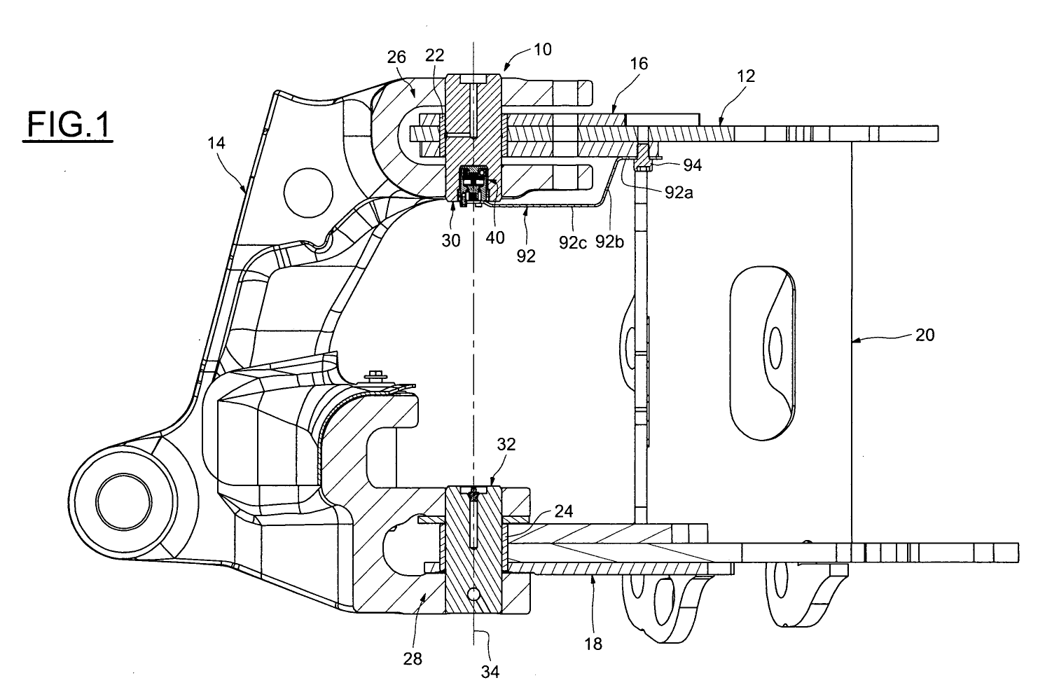

FIG. 1 depicts an instrumented joint system denoted by the overall numerical reference 10, intended to connect a first part 12, in this instance fixed and secured to a chassis (not depicted) of earthmoving plant and a second part 14 that forms an articulated arm able to move with respect to the first part 12. The plant may, for example, be a power shovel.

The fixed first part 12 in particular includes two connecting elements 16, 18 which are parallel and joined together by a spacer piece 20 that runs transversely.

To allow the joint system 10 to be mounted such that it can rotate with respect to the fixed first part 12, the latter also includes plain bearings 22, 24 mounted near the free ends of the connecting elements 16 and 18 respectively.

The moving second part 14 has, in cross section, the overall shape of a U. Each end of the U includes a clevis 26, 28 surrounding the connecting elements 16 and 18 respectively.

In order to articulate the moving second part 14 with respect to the fixed first part 12, the system 10 includes a first pivot pin 30 mounted on the clevis 26, and a second pivot pin 32 positioned at the clevis 28. The pivot pins 30, 32 have a common axis 34.

More specifically, the first pivot pin 30 is mounted to rotate with respect to the fixed first part 12 about the axis 34, via the bearing 22. It is rigidly fixed to the moving second part 14 at the clevis 26. The second pivot pin 32 is mounted to rotate with respect to the fixed first part 12 about the axis 34, via the bearing 24.

In order to detect the angular displacement of the moving second part 14 relative to the fixed first part 12, the system 10 also includes a detection assembly 40 that detects rotation parameters and is mounted inside the pivot pin 30.

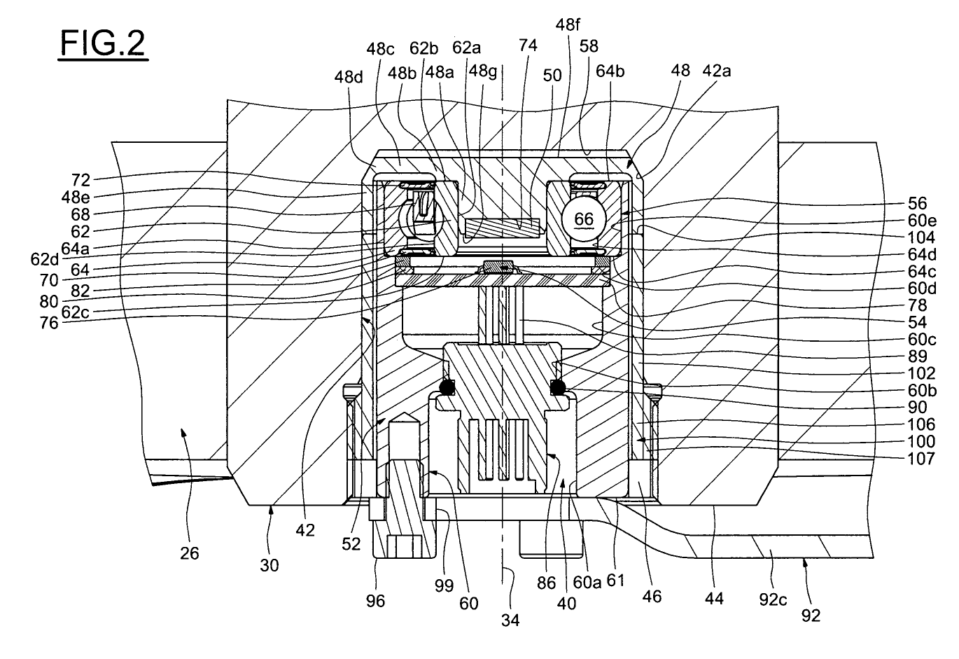

As illustrated more clearly in FIG. 2, the detection assembly 40 is mounted inside a cylindrical bore 42, centered on the axis 34 and formed from a radial end surface 44 of the pivot pin 30. The bore 42 delimits a housing 46 completely inside which the detection assembly 40 is mounted.

The detection assembly 40 chiefly includes a support 48 including an encoder element 50, a sleeve 52 supporting a sensor element 54 axially facing the encoder element 50 and a rolling bearing 56 positioned between the support and the sleeve.

The support 48 includes an inner axial portion 48a which is extended outwards, from one axial end, by a first radial portion 48b itself extended outwards by a second radial portion 48c of smaller axial dimension. The radial portion 48c is extended from a large-diameter edge by a frustoconical portion 48d which widens outwards, itself axially extended by an outer tubular axial portion 48e which radially surrounds the first portion 48a. The support 48 is axially delimited by radial transverse end surfaces 48f and 48g.

The support 48 is mounted axially inside the bore 42 of the pivot pin 30. More specifically, the radial transverse end surface 48f lies near an end wall 58 of the bore 42. The outer tubular axial portion 48e of the support 48 is housed with a small radial clearance inside the bore 42 of the pivot pin 30. As will be described in greater detail later, the frustoconical portion 48d, for its part, forms a portion that wedges and centers the said support inside the bore 42.

The sleeve 52, centered on the axis 34, has a tubular overall shape. The sleeve 52 completely lies axially inside the housing 46 and remains radially distant from the cylindrical bore 42. In other words, there is a radial gap between the exterior surface of the sleeve 52 and the bore 42. The sleeve 52 has a stepped bore 60 formed from one radial end surface 61 which is axially offset relative to the end surface 44 towards the end wall 58. The bore 60 extends over the entire length of the sleeve 52. The said sleeve has a hollow overall shape.

The bore 60 includes a first stage 60a extending from the end surface 51 and extended at one axial end by a second stage 60b of smaller diameter, itself extended at an axial end that is at the opposite end to the first stage 60a by a third stage 60c of a diameter greater than the diameter of the first stage 60a. The third stage 60c is extended at one axial end by a fourth stage 60d, itself extended axially at the opposite end to the third stage 60c by a fifth stage 60e of larger diameter. The fifth stage of the bore 60e extends axially partly into the annular space delimited between the inner 48a and outer 48e first and second axial portions of the support 48 up to close to the radial portion 48c. In other words, the outer portion 48e at least partially radially surrounds the sleeve 52, leaving a radial gap between the said sleeve and the support.

The rolling bearing 56, which is a deep groove bearing with radial lateral faces is a standard rolling bearing with a low cost of manufacture. It includes an inner ring 62, an outer ring 64, between which rings there is housed a row of rolling elements 66 produced here in the form of balls, a cage 68 for maintaining the circumferential spacing of the rolling elements, and two seals 70 and 72.

The inner ring 62 is of the solid type. A “solid ring” is to be understood to mean a ring the shape of which is obtained by machining with the removal of material (by turning, grinding) from tube stock, bar stock, forged and/or rolled blanks.

The inner ring 62 has a bore 62a of cylindrical shape pushed on to the exterior surface of the axial portion 48a of the support 48 and delimited by opposite radial lateral surfaces 62b and 62c. The radial lateral surface 62b is mounted against the radial portion 48b which thus forms an axial thrust surface for the rolling bearing 56. The inner ring 62 also includes an outer cylindrical surface 62d from which a toroidal circular groove (unreferenced) is formed, this groove having in cross section, a concave internal profile capable of forming a raceway for the rolling elements 66, the said groove facing outwards.

The outer ring 64, also of the solid type, includes an outer cylindrical surface 64a push-fitted into the fifth stage 60e of the bore 60 of the sleeve 52 and delimited by opposite radial lateral surfaces 64b and 64c. The radial lateral surface 64c bears against a radial surface of the bore 60 formed between the fifth stage 60e and the fourth stage 60d of the said bore. This surface thus forms an axial thrust surface for the rolling bearing 56.

The outer ring 64 also includes a bore 64d of cylindrical shape from which a toroidal circular groove (unreferenced) is formed, this groove in cross section having a concave internal profile capable of forming a raceway for the rolling elements 66, the said groove facing inwards.

The outer ring 64 also includes, at the bore 64d and near the radial surfaces 64b and 64c, two sealing ring grooves (unreferenced) which are annular and symmetric with one another with respect to a radial plane passing through the centre of the rolling elements 66. The seals 70 and 72 for preventing the ingress of undesirable external elements into the rolling bearing 56 are mounted in the said sealing ring grooves.

As indicated previously, in order to allow the angular displacement of the moving second part 14 relative to the first part 12 to be detected, the detection assembly 40 includes the encoder element 50 and the sensor element 54 lying substantially axially facing the said encoder element.

The encoder element 50 is mounted in a housing 74 formed from the radial end surface 48g. Thus, the encoder element 50 is mounted at one axial end of the support 48, the opposite end to the end wall 58 of the pivot pin 30. The encoder element 50 in this instance is centred on the axis 34, projecting slightly in the axial direction with respect to the radial end surface 48g. The encoder element 50 may, for example be produced in the form of a magnet of cylindrical overall shape. It is fixed inside the housing 74 by any appropriate means.

The sensor element 54, for its part, includes a sensor-forming active part 76 and a rigid printed circuit board 78 forming a plate which supports the sensor 76 and is mounted bearing against a radial surface delimited by the third stage 60c and the fourth stage 60d of the bore 60 of the sleeve 52.

The sensor 76 is mounted axially facing the encoder element 50 with a small axial air gap. The sensor 76 may be of the magnetosensitive type and include, for example, a magnetoresistor or an array of Hall effect sensors. The sensor 76 is positioned a short axial distance away from the encoder element 50, which keeps the assembly 40 suitably compact.

The printed circuit board 78 is capable of processing data or signals transmitted by the sensor 76 which are representative of the angular position of the moving second part 14 with respect to that of the fixed first part 12. In this respect, the board 78 may include a circuit for preprocessing the transmitted signals.

To allow the printed circuit board 78 to be mounted inside the bore 60, the system 10 also includes two thrust washers 80 and 82 mounted axially bearing against one another and in contact with the fourth stage 60d of the bore 60.

The thrust washer 80 is mounted axially against a surface of the printed circuit board 78. The thrust washer 80 is made of a relatively rigid material, for example, steel. The thrust washer 82 is, for its part, mounted axially between the thrust washer 88 and the radial surface 64c of the outer ring 64 of the rolling bearing 56. The washer 82 is made of flexible elastic material, for example, elastomer.

Thus, the thrust washer 82 axially preloads the thrust washer 80 against the printed circuit board 78 making it possible in particular to absorb any potential dimensional variations thereof and guarantee that the board 78 is always correctly axially positioned with no axial play. As an alternative, it could also be conceivable for an axially elastic corrugated washer to be used for this purpose.

In order to allow control of the moving second part 14 on the basis of the signals transmitted by the sensor 54, the system 10 also includes a control unit (not depicted) which may include a filter element, an analogue/digital converter for converting the signals transmitted by the said sensor.

To connect the control unit to the printed circuit board 78, the detection assembly 40 also includes a connector 86 mounted inside the second stage 60b of the bore 60 of the sleeve 52. The connector 86 extends axially outwards, while still, however, being completely housed inside the bore 60.

More specifically, the connector 86 is completely housed inside the sleeve 52, one axial end of the said connector being set back slightly from the end surface 61. Given the hollow shape of the sleeve 52, the connector 86 can be easily electrically connected to the outside of the system without there being any need to provide in the said sleeve, special routing for an electric lead and/or the use of additional fixings. This then simplifies the design of the sleeve 52 and, more generally, of the system 10.

The connector 86 is connected to the printed circuit board 78 via electrical connections 89 which extend axially between these two elements inside the third stage 60c of the bore 60. A seal 90 is also provided between the second stage 60b of the bore 60 and the connector 86.

In order to allow an annular connection between the sleeve 52 and the fixed first part 12, the system 10 includes a bracket 92. This bracket is provided with a first radial portion 92a (FIG. 1) which is fixed against the connecting element 16 of the first part 12, using a fixing screw 94. The radial portion 92a is extended by a substantially axial portion 92b, itself extended at one axial end by a second radial portion 92c extending axially away from the clevis 26 up to close to the radial end surface 44 of the pivot pin 30. The radial portion 92c bears against the radial end surface 61 of the sleeve 52. The sleeve 52 is fixed to the bracket 92 using fasteners 96 such as screws, housed in holes 98 formed on the end surface 44. In this instance there are three holes 98. To allow ease of access to the connector 86 for the purposes of making an electrical connection, the radial portion 92c of the bracket includes, near its free end, an opening 99.

In order to maintain axial contact between the pivot pin 30 and the support 48, the system 10 also includes a sleeve tube 100 bearing against the said support and at least partly radially surrounding the sleeve 52. The sleeve tube 100 includes a tubular axial portion 102 mounted inside the bore 42 of the pivot pin 30 in contact therewith, the free end of the said portion forming a bearing or thrust surface 104 for bearing against the axial portion 48e of the support 48. The axial portion 102 radially surrounds the sleeve 52 remaining distant therefrom.

The sleeve tube 100 also includes a radial flange 106 situated axially at the opposite end to the thrust surface 104. The flange 106 on its external surface includes a screw thread 107 so that the sleeve tube 100 can be screwed into the bore 42. A corresponding screw thread (unreferenced) is formed on a part of the said bore 42. Of course, instead of the screw thread it might be possible to provide some other appropriate means of attachment for holding the sleeve tube 100 on the pivot pin.

When the sleeve tube 100 is screwed into the bore 42, the thrust surface 104 first of all comes to bear against the axial portion 48e of the support 48. Thereafter, the sleeve tube 100 exerts on the support 48 an axial force directed towards the end wall 58 and which tends to push it into the end of the housing 43. The sleeve tube 100 is able to maintain contact pressure between the frustoconical portion 48d of the support 48 and a frustoconical part 42a of the housing 46 of the pivot pin 30, the said frustoconical part 42a connecting the cylindrical portion of the bore 42 to the end portion 58 of the housing 46. The sleeve tube 100 further constitutes a means of axially retaining the support 48 inside the housing 43.

In other words, screwing the sleeve tube 100 in causes the support 48 to move axially towards the end wall 58 until the support is fastened into the bore 42, by wedging of the frustoconical portion 48d which comes to bear against a surface of the frustoconical part 42a the shape of which matches with the said pin. The frustoconical surface 48d also ensures perfect centering between the support 48 and the pivot pin 30.

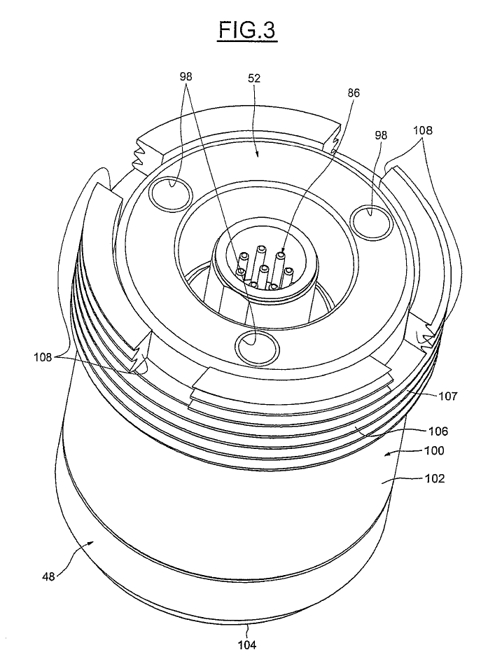

In order to be able to screw the sleeve tube 100 in, axial notches 108 visible in FIG. 3 are formed on the flange 106 so that a side notch nut pin wrench (not depicted) can be applied.

In operation, when the second part 14 pivots angularly with respect to the first part 12, the pivot pin 30 is also turned about the axis 34. Thus, the support 48 which is angularly secured to or of one piece with the said pin is turned, the sleeve 52, for its part, remaining stationary. The relative angular displacement is detected by the encoder element 50 and the sensor element 54.

This then yields a system including a pivot pin and a built-in assembly for detecting rotation parameters which is completely housed inside the sleeve, which is itself positioned inside the housing of the pivot pin. The detection assembly, and especially its connector, is thus effectively protected from knocks and the various contaminants originating from the external surroundings. This measure makes also it easier to mount the pivot pin which can be fitted simply by pushing it axially.

Furthermore, the use of a clamping sleeve tube in order to fix the support inside the bore of the pivot pin makes mounting the system easier and also makes disassembling the system easier. This is because once the sleeve tube has been removed, all that is required is for the sleeve to be pulled in order for the detection assembly to be extracted from the housing in the main pin. The sleeve, the support, the clamping sleeve tube, the rolling bearing, the encoder, the sensor, the electronic board and the connector are thus in the form of a compact module that can be easily mounted in the housing in the pin provided for this purpose or can easily be removed from the said housing if necessary.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. Instrumented joint system including a pivot pin capable of connecting a first part and a moving second part that can pivot with respect to the first part, and a detection assembly for detecting rotation parameters of the second part and which is mounted inside a housing of the pivot pin, the said detection assembly including at least one rolling bearing provided with an inner ring and with an outer ring, and a sleeve angularly connected to the outer ring, wherein the detection assembly is further provided with a support angularly connected to the pivot pin and on which the inner ring of the bearing is mounted, and with a retaining means for retaining the support axially inside the housing.

2. System according to claim 1, in which the axial-retention means includes a sleeve tube provided with a fixing portion for fixing to the pivot pin and with a bearing surface for the support.

3. System according to claim 1, in which the support includes an outer tubular axial portion positioned inside a cylindrical bore of the housing.

4. System according to claim 3, in which the outer tubular axial portion at least partially radially surrounds the sleeve leaving a radial gap between the said sleeve and the support.

5. System according to claim 1, in which the support includes a frustoconical wedging portion able to cooperate with a portion of complementary shape belonging to a bore of the housing of the pivot pin.

6. System according to claim 1, in which the sleeve is completely housed inside the housing of the pivot pin.

7. System according to claim 1, in which the sleeve includes a stepped bore in which to mount elements of the detection assembly.

8. System according to claim 7, in which the detection assembly includes a connector extending axially inside the sleeve.

9. System according to claim 1, in which the detection assembly includes an encoder element mounted at one axial end of the support and a sensor element situated axially facing the said encoder element.

10. System according to claim 9, in which the sensor element is mounted against a printed circuit board bearing against a thrust surface of the sleeve.

11. Earthmoving machine including an instrumented joint system according to claim 1.
